(19) United States
(12) Patent Application Publication
(10) Pub. No.: US 2014/0263043 A1
(43) Pub. Date: Sep. 18, 2014

(54) S/M FOR BIOLOGICAL TREATMENT OF WASTEWATER WITH SELENIUM REMOVAL

(71) Applicant: Infilco Degremont, Inc., Richmond, VA (US)

(72) Inventors: Sunil Mehta, Henrico, VA (US); Raed Labban, Glen Allen, VA (US)

(73) Assignee: Infilco Degremont, Inc., Richmond, VA (US)

(21) Appl. No.: 13/838,419

(22) Filed: Mar. 15, 2013

(51) Int. Cl. C02F 3/28; C02F 1/28

(52) U.S. Cl. CPC C02F 3/286; C02F 1/281
USPC 210/610; 210/601; 210/631; 210/259; 210/202; 210/195.1

(57) ABSTRACT

The present invention is directed to systems and methods of treating wastewater. The present invention may include a method of treating such wastewater comprising selenium in the form of water soluble selenates, selenites, and/or selenides, the method including: a chemical/biological treatment process, causing the water soluble selenates, selenites, and/or selenides in the wastewater to be converted into insoluble elemental selenium; and a physical treatment process, trapping the insoluble elemental selenium in a filtration device. Systems and methods in accordance with the present invention may also include a system for including: one or more chemical/biological treatment reactors, the one or more chemical/biological treatment reactors configured to cause the water soluble selenates, selenites, and/or selenides in the wastewater to be converted into insoluble elemental selenium; and one or more physical treatment devices, the one more physical treatment devices configured to trap the insoluble elemental selenium in a filtration device.

### BACKGROUND OF THE INVENTION

The present invention is generally directed to systems and methods for treating wastewater to remove undesirable solids, nitrogen, sulfides, and heavy metals. Specifically, the present invention is directed to systems and methods for treating wastewater to reduce the nitrates and heavy metals to an acceptable amount.

Various types of wastewater may comprise different forms of selenium. For example, coal-fired power plants continue to produce a significant proportion of the electricity requirements for the United States. The combustion and gasification of coal is widely recognized as a significant environmental issue due to the potential release of hazardous pollutants. As a consequence, air quality standards continue to tighten. This results in the implementation of scrubbers for emissions control.

Wet scrubber technology with lime slurry/limestone is a proven and commercially established process for flue gas emissions control, particularly SO.sub.2 removal, from coal-fired power plants. However, such wet scrubbers produce what is known as Flue Gas Desulfurization (FGD) wastewater, which often contains elevated levels of chlorides; significant concentrations of heavy metal contaminants such as chromium, mercury, and selenium; often high levels of nitrates; and a very high solids content that consists primarily of calcium sulfate, calcium carbonate, magnesium hydroxide, and fly ash.

Treatment of FGD wastewater is a significant need for utility operations. Physical/chemical treatment processes are typically used for neutralization and calcium sulfate desaturation, removal of some heavy metals, clarification and sludge thickening. However, conventional chemical precipitation techniques do not reliably eliminate heavy metal contaminants such as selenium and hexavalent chromium below outfall discharge limits established by newer, more stringent regulatory requirements. Nor do these current practices remove nitrogenous pollution.

Wastewater of various types—such as FGD wastewater—is the focus of increasingly stringent effluent requirements, with outfall discharge standards (monthly average and daily maximum) typically established for: pH Total Suspended Solids (TSS) Total Nitrogen (TN) Heavy Metals including but not limited to Arsenic, Chromium, Copper, Mercury & Selenium.

Wastewater either resulting from or used in other activities—such as mining, surface and subsurface water, may also be contaminated with selenium and require treatment.

Selenium exists in multiple valence states in the natural environment and the impact of selenium speciation on treatment efficiency is known. Selenium is an essential micronutrient for animals and bacteria. However, it becomes highly toxic when present above minute concentrations. The oxidized species of selenium, selenate (Se VI) and selenite (Se IV), are highly soluble and bioavailable, whereas reduced forms are insoluble and much less bioavailable.

New selenium regulations have recently moved towards a lower allowable limit than previously. Accordingly, current selenium wastewater discharge standards may be limited an aquatic standard at or near five (5) parts per billion (ppb). This standard may apply to industrial facilities including power plants, agricultural run-off discharge, and refinery sour water stripper bottoms.

Biological treatment for heavy metals removal is known and accepted in the art. Suspended growth activated sludge systems are often used in a biological treatment process for the removal of organic and inorganic pollutants from various types of wastewaters. Biological treatment has proven effective for removal of particular heavy metals of concern in wastewaters, such as selenium, by reduction and precipitation reactions. For example, methods and systems for the biological treatment of flue gas desulfurization wastewater are set forth in U.S. Pat. No. 7,985,576, granted on Jul. 26, 2011, where is incorporated herein by reference in its entirety.

It would therefore be desirable to provide an enhanced biological treatment approach to circumvent problems known in the prior art, optimizing downstream removal of selenium and other heavy metals from wastewater while maintaining sulfur dioxide removal efficiency.

### SUMMARY OF THE INVENTION

Aspects in accordance with some embodiments of the present invention may include a method of treating wastewater comprising selenium in the form of water soluble selenates, selenites, and selenides, the method comprising: a chemical/biological treatment process, causing the water soluble selenites and/or selenides in the wastewater to be converted into insoluble elemental selenium; and a physical treatment process, trapping the insoluble elemental selenium in a filtration device.

Other aspects in accordance with some embodiments of the present invention may include a method of treating wastewater comprising selenium in the form of water soluble selenates, selenites, and selenides, the method comprising: introducing the wastewater into an anoxic biological reactor, the anoxic biological reactor substantially denitrifying and/or reducing the heavy metals in the wastewater, and providing the output of the anoxic biological reactor as an input to the anaerobic biological reactor, introducing the wastewater into an anaerobic biological reactor, the anaerobic biological reactor substantially reducing the amount of sulfate and/or reducing the heavy metals in the wastewater, the anaerobic biological reactor comprising selenium reducing organisms to reduce selenates, selenites and/or selenides into insoluble elemental selenium; and a physical treatment process, trapping the insoluble elemental selenium in a filtration device.

Some aspects in accordance with some embodiments of the present invention may include a method of treating wastewater comprising selenium in the form of water soluble selenates, selenites, and selenides, the method comprising: introducing the wastewater into an anoxic biological reactor, the anoxic biological reactor substantially denitrifying and/or reducing the heavy metals in the wastewater, and providing the output of the anoxic biological reactor as an input to the anaerobic biological reactor, introducing the wastewater into an anaerobic biological reactor, the anaerobic biological reactor substantially reducing the amount of sulfate and/or reducing the heavy metals in the wastewater, the anaerobic biological reactor comprising selenium reducing organisms to reduce selenates, selenites, and/or selenides into insoluble elemental selenium; and a physical treatment process, comprising the use of filters using granulated activated carbon to trap the insoluble elemental selenium.

Still other aspects in accordance with some embodiments of the present invention may include a system for treating wastewater comprising selenium in the form of water soluble selenates, selenites, and selenides, the system comprising: one or more chemical/biological treatment reactors, the one or more chemical/biological treatment reactors configured to cause the water soluble selenates, selenites, and/or selenides in the wastewater to be converted into insoluble elemental selenium; and one or more physical treatment devices, the one more physical treatment devices configured to trap the insoluble elemental selenium in a filtration device.

Aspects in accordance with some embodiments of the present invention may include a system for treating wastewater comprising selenium in the form of water soluble selenates, selenites, and selenides, the system comprising: one or more chemical/biological treatment reactors, the one or more chemical/biological treatment reactors configured to cause the water soluble selenates, selenites, and/or selenides in the wastewater to be converted into insoluble elemental selenium; and one or more physical treatment devices, the one more physical treatment devices configured to trap the insoluble elemental selenium in a filtration device; and an anaerobic biological reactor configured to substantially reduce the amount of sulfate and/or reduce the heavy metals in the wastewater, the anaerobic biological reactor comprising selenium reducing organisms to reduce selenates, selenites and/or selenides into insoluble elemental selenium.

These and other aspects will become apparent from the following description of the invention taken in conjunction with the following drawings, although variations and modifications may be effected without departing from the spirit and scope of the novel concepts of the invention.

### BRIEF DESCRIPTION OF THE DRAWING

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 is a schematic diagram of a representative process flow for a wet-oxidation scrubber/absorber system and associated conventional wastewater treatment system.

FIG. 2 is a schematic flow diagram of a representative biological treatment system for wastewater.

FIG. 3 is a schematic diagram of an exemplary system in accordance with some embodiments of the present invention.

FIG. 4 is a schematic diagram of an exemplary system in accordance with some embodiments of the present invention.

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

### DETAILED DESCRIPTION

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular.

It will be understood that the specific embodiments of the present invention shown and described herein are exemplary only. Numerous variations, changes, substitutions and equivalents will now occur to those skilled in the art without departing from the spirit and scope of the invention. Accordingly, it is intended that all subject matter described herein and shown in the accompanying drawings be regarded as illustrative only, and not in a limiting sense, and that the scope of the invention will be solely determined by the appended claims.

This disclosure also relates to processes for biological treatment of wastewater, particularly to treatments that improve the removal efficiency of TN and heavy metals including but not limited to selenium

In general, this disclosure relates to systems and methods of biological treating wastewater in order to improve the total nitrogen (TN) removal efficiency as well as remove, among other elements and heavy metals, selenium. Systems and methods in accordance with the present invention may combine both chemical/biological treatment of wastewater with physical treatment. More specifically, chemical and/or biological treatment of wastewater may cause various contaminants in the wastewater to be converted to elemental selenium. Physical treatment of material with specific surface characteristics may then trap any selenium.

Moreover, in accordance with some embodiments of the present invention, the systems may include the feed of a pure organic acid conditioning reagent, such as formic acid, to the wet-oxidation scrubber/absorber and later followed by a combination of anoxic, anaerobic and aerobic staged activated sludge reactors and associated clarification systems for removal of TN, reduction and precipitation of heavy metals and elimination of suspended solids from purge streams, and later physical treatment of the wastewater in order to physically capture and remove any remaining elemental selenium.

FIG. 1 sets forth systems and methods as known in the art, particularly as set forth in U.S. Pat. No. 7,985,576, granted on Jul. 26, 2011, where is incorporated herein by reference in its entirety. FIG. 1 depicts a selected, representative pollution control system 10 to remove wastewater contaminants.

System 10 may comprise, in general, a conditioning reagent feed line 12, an absorber 14, a particle scrubber 16, a recirculation tank 18, a reheater 26, one or more stacks 28, a fan 30, a clarifier 34, a holding tank 36, a vacuum filter 40, and a settling pond 44. These components generally interact as follows.

Conditioning reagent feed line 12 provides a conditioning reagent, such as formic acid, to absorber 14, while absorber 14 may be connected to particle scrubber 16 and recirculation tank 18. The recirculation tank 18 may directly receive treatment fluid (i.e., the wastewater to be treated) through supply line 20 which may be indirectly supplied into absorber 14 by way of line 22. Treatment fluid (or wastewater to be treated) may comprise, among other things, a lime/limestone water slurry. Treated flue gases exit absorber 14 through line 24, are reheated by reheater 26 and then moved to stack 28 by fan 30.

On the other end, wastewater exits absorber 14 through line 32 and enters recirculation tank 18. Selected portions of wastewater exit through recirculation tank 18 and may proceed to clarifier 34. This may be followed by passage of the clarified wastewater to holding tank 36. Wastewater contained in holding tank 36 can be recycled to recirculation tank 18 by way of line 38. The partially dewatered sludge may be channeled from clarifier 34 to vacuum filter 40 by way of line 42, where most of the remaining water is removed. The waste sludge can then be sent to a settling pond or landfill 44.

In accordance with selected aspects of this disclosure, wastewater may also flow from clarifier 34 to additional treatment systems such as a biological treatment by way of line 46 and as activated by valve 47.

With reference to FIG. 2, a selected, representative biological treatment system 48 for wastewater is shown in a schematic form. The system 48 includes an inlet 50, a staged suspended growth biological reactor 52 comprising anoxic 54 and anaerobic 56 zones, an intermediate clarifier 58, an aerobic suspended growth biological reactor 60, a final clarifier 62, a storage tank 64 and a filtration stage 76.

The biological treatment system 48 of FIG. 2 can perform the following functions: Anoxic Stage—Denitrification (Nitrate reduction) and/or reduce selected heavy metals Anaerobic Stage—Selected heavy metal reduction and precipitation, particularly Selenium reduction Aerobic Stage—Nitrification (ammonia reduction) and organics reduction.

The biological treatment system 48 may receive influent feed from an upstream physical-chemical treatment system such as from clarifier 34, for example, of FIG. 1, in the form of deoxygenated purge wastewater. The biological reactors of the system 48 may include completely mixed, continuous flow, activated sludge reactors.

The first cell (or reactor 54) in the system 48 is the anoxic stage, where nitrates are reduced to nitrogen gas via denitrification reactions. As wastewater is deficient in macronutrients, including ammonia nitrogen and orthophosphorous, as well as many of the micronutrients required to support biological growth, there is a process requirement for supplemental nutrient addition to yield efficient treatment performance. Reactor 54 is thus fed with a biodegradable nutrient blend, containing macro- and micronutrients to maintain microbial growth.

Nutrients include but are not limited to supplemental carbon such as waste sugar, corn syrup, molasses or the like, urea or the like to provide ammonia nitrogen, phosphoric acid, micronutrients and yeast extract to provide necessary trace metals and growth factors. Fermentation of sugars dosed into the anoxic reactor 54 results in the conversion of sucrose to volatile fatty acids (VFAs) that sulfate/selenium reducing microorganisms are capable of metabolizing efficiently in the downstream anaerobic reactor stage(s). Additional carbon sources such as lactate, acetate or the like may also be added directly to the anoxic/anaerobic reactors to enhance selenium removal by enriching the selenium reducing microorganisms.

Further, addition of a pure organic acid stream, such as formic acid, through line 12 of absorber 14 provides a means to introduce a biodegradeable carbon substrate to the wastewater that can provide COD to the system for downstream biological removal of nitrates and selected heavy metals. For example, using the COD factor for formic acid of 0.35, a dosage of 200 mg/L formate equates to a theoretical COD dosage of about 70 mg/L.

The anoxic/anaerobic biological reactor 52 may be an overflow, under-flow weir design which mimics a plug-flow system without the need to incorporate separate reactor tanks that are physically isolated from one another. Other configurations/structures may be used as appropriate. Operational inputs for successful treatment involve targeting the appropriate oxidation-reduction potential (ORP) in the various reactor stages. Thus, the anoxic reactor 54 may preferably be maintained in the range of about −50 to about −300 mV to yield efficient denitrification.

The anoxic denitrification reactor 54 plays a role in the efficient removal of selected heavy metals such as selenium, as such removal appears to depend, at least in part, upon sequential substrate removal, specifically the prior elimination of nitrates.

Additionally, the efficiency of selenium removal appears to be dependent upon the species present in the wastewater matrix. It is known that selenite (Se IV) is somewhat efficiently removed via physical chemical means while selenate (Se VI) requires biological treatment to obtain significant reductions. Notably, efficient biological removal appears to depend on the nature of complexes, such as organo-selenium compounds, formed within the wastewater matrix and addition of reagent additives to the scrubber/absorber heavily impacted the contaminants formed. Many organic complexes of selenium formed as a result of the use of organic acid containing manufacturing waste by-product mixtures at the absorber. Such organo-selenium complexes were found to be recalcitrant to selenium reduction by the microbial population in downstream biological reactors. The use of a pure organic acid reagent, such as formic acid, to improved SO₂ removal efficiency at the scrubber further provides downstream advantages by yielding a wastewater matrix that could be treated for selenium removal. The staged biological reactors may create a reducing environment for the conversion of selenate or selenite to elemental selenium, which precipitates out of solution into the wastewater solids.

The partially treated wastewater accordingly leaves the anoxic reactor 54 substantially devoid of nitrate contamination and flows into the next cell (i.e., the anaerobic reactor 56), which in one aspect may be operated at an oxidation-reduction potential (ORP) in the range of about −200 to about −500 mV, where sulfate and heavy metal-reducing organisms begin to remove sulfates and the selected heavy metals from the wastewater. The treated water then flows to an optional third cell (anaerobic reactor stage) to ensure that heavy metals are removed to levels allowing outfall discharge permits to be met.

The treated effluent from the anoxic/anaerobic biological reactors 54/56 may flow into a mix chamber allowing for chemical addition to improve downstream sedimentation within the intermediate clarifier 58. From the mix chamber of the anoxic/anaerobic reactors 54/56, the treated effluent flows into a settling type intermediate clarifier 58, where the total suspended solids may be settled out and the clarifier underflow solids may be recycled to the anoxic reactor 54 by lines 66 and 68 as return activated sludge (RAS) or sent to a sludge holding tank (not shown) by line 70 as waste activated sludge (WAS).

From the intermediate clarifier 58, the partially treated wastewater may flow into a sand filter or ultra-filtration (UF) membrane 78 followed by an activated carbon filter 80. The sand filter or UF membrane may physically separate particles from the wastewater. Note that while sand filters and UF membranes are discussed, other known forms of suspended solid separation means, such as nanofiltration membranes are also contemplated by the present invention.

Granulated Activated Carbon (GAC) or other adsorbent materials such as charred poultry waste or the like added to the anaerobic and/or aerobic biological reactor may also adsorb any remaining organo-selenium complexes to assist reaching a final effluent selenium concentration that is below approximately 200 μg/L.

From the activated carbon filter 80, the wastewater flows into the aerobic biological reactor 60 for removal of BOD and ammonia. In one aspect, the aerobic biological reactor 60 includes operation at positive ORP.

From the aerobic reactor 60, the wastewater flows into a settling type final clarifier 62, where TSS is settled out and clarifier underflow solids may be recycled to the head of the aerobic reactor 62 by lines 72 and 74 as RAS or sent to a sludge holding tank (not shown) by line 70 as WAS.

Finally, the clarified water may flow into a wet effluent well/tank 64 for pumping to pressure filters 76 and ultimately discharge to the environment. The filters may be gravity sand, multimedia or the like type filters.

The benefits brought about by the methods and systems described above may include: The complexity of Selenium speciation within wastewaters may be reduced or eliminated by feeding a pure organic acid conditioning additive, such as formic acid, to the wet-oxidation scrubber/absorber. Subsequently, this approach improves downstream biological treatment while maintaining SO₂ removal efficiency at the absorber. Use of a staged biological reactor approach to support the growth of distinct groups of bacteria within the naturally occurring population. Use of conventional suspended growth activated sludge technology eliminates need to backwash or flush reactors periodically to remove captured waste material. Reactors are seeded with biomass from natural microbial populations avoiding the need to regularly add “specialized” microbial cultures and thereby reducing annual operational costs. Treatment approach provides operational flexibility and stable operations/performance under highly variable influent conditions. Biological removal of selenocyanate forms and other complexed selenium species that may be more difficult to remove with conventional iron-coprecipitation treatment strategies.

With reference to FIG. 3, a system 30 in accordance with some embodiments of the present invention will now be discussed. System 30 may comprise, in general, an anoxic reactor 330, an anaerobic reactor 340, an anaerobic clarifier 350, and a filter 360. The anoxic reactor 330 may receive inputs from a wastewater holding tank 310, a carbon source holding tank 311, and/or a nutrient holding tank 312. The inputs may be fed into the anoxic reactor 330 via gravity feed or through assistance, for example, through the use of a peristaltic pump 321, 322, 323. The anoxic reactor 330 may mix the inputs through the use of, for example, an impeller. Various controls, such as temperature, etc. may impact the anoxic reactor. The anoxic reactor 330 may also receive a return activated sludge flow from the anaerobic clarifier 350. Filter 360 may comprise any type of filter that physically separates or captures various components from the wastewater stream received from the anaerobic clarifier 350.

Note that other aspects of the system 30 may be included, such as odor control modules, etc. In operation, the influent wastewater may be pumped from the wastewater holding tank 310 into the anoxic reactor 330. The anoxic reactor 330 may be inoculated with denitrifying bacteria from a wastewater sludge. This may be provided via the return of activated sludge from the anaerobic clarifier 350. Note that while holding tanks 310, 311, 312 are discussed, such material may be provided directly to the anoxic reactor 330 without the use of such holding tanks. For example, in the case of a treatment facility, the system 30 may receive wastewater as it is generated. Carbon source and nutrients from holding tanks 311, 312 may be pumped from their respective tanks into the anoxic reactor 330, and mixed with the influent wastewater and the anaerobic sludge. The resultant mixed liquor may then travel to the anaerobic reactor, for example by gravity-feed or through the use of a pump or other physical assistance. Following the anaerobic reactor, the liquor may flow into the anaerobic clarifier 350 where, as noted above, anaerobic sludge may settle from gravity and may be recycled back to the anoxic reactor 330. A clarified effluent may flow from the anaerobic clarifier 350 through a filter for final polishing by removing any residual suspended solids and/or any remaining elemental selenium.

Vent gases from the reactors 330, 340, the clarifier 350 and the filter 360 may be collected and sent to an odor control bioreactor for the removal of the odor-causing hydrogen sulfide.

In general, operational steps of the system 30 may be as follows. First, there may be an addition of urea, phosphoric acid, micro-nutrients, a carbon source (for example, sugar). Nitrites, nitrates, and selenium may be removed from the wastewater in the anoxic reactor 330. Selenium may be further removed in the anaerobic reactor 340. Sedimentation may then occur, with the anaerobic activated sludge thickening and clarifying in the anaerobic clarifier 350. At least a portion of the anaerobic activated sludge may be recycled and provided as an input to the anoxic reactor 330. At this point, the total suspended solids (TSS) in the effluent may be polished and/or filtered by the filter 360. Post treatment of the effluent may occur, in which additional elemental selenium may be trapped, for example, through the use of an adsorption material, such as granulated activated carbon.

With reference to FIG. 4, another system in accordance with some embodiments of the present invention will now be discussed. FIG. 4 comprises, in general, a pH adjustment tank 410, an anoxic reactor 420, an anaerobic reactor 430, a clarifier 440, a first filter 450, a second filter 460, a third filter 470, and an effluent holding tank 480. The filters 450, 460, 470 may be similar or different types of filters. For example, the first filter may be a sand filter, the second filter may be a carbon filter, and the third filter may be another carbon filter.

The pH adjustment tank 410 may receive an influent 41 as well as a feed of acid 411, or any other material that may appropriately adjust the pH of the influent. Once the pH has been adjusted to the desired range, the fluid may be passed on to the anoxic reactor 420.

The anoxic reactor may receive as inputs the fluid from the pH adjustment tank 410, as well as a feed of macro nutrients 421, a carbon source 422, and micro nutrients 423. The anoxic reactor may also receive as an input a portion of activated sludge received from the clarifier 440. Upon treatment of the fluid, the anoxic reactor may output the fluid to anaerobic reactor 430, and subsequently the fluid may flow to clarifier 440. Anoxic reactor 420, anaerobic reactor 430, and clarifier 440 may operate as discussed above with regard to similar components.

Clarifier 440 may output sludge waste 441, and may return a portion of such sludge waste to anoxic reactor 420 as an input. Clarifier may output treated fluid to the first filter 450. FIG. 4 indicates three (3) filters (450, 460, 470). Note that the number of filters is not essential to the present invention, but rather the functionality and performance of the filtration is desired. In other words, filters 450, 460, 470 are used to polish the effluent and to remove elemental selenium from the effluent. However, this may be accomplished using any number of filters and any type of filters. The use of three (3) filters in FIG. 4 is exemplary only, as is the discussed potential arrangement of a sand filter followed by two (2) carbon filters.

Following treatment by the one or more filters, the effluent may be held in an effluent holding tank 480, from which a portion may be returned to the one or more filters as an input. Treated effluent 42 may also exit the system from the effluent holding tank 480.

Note that backwash air and/or water 490 may be utilized to periodically clean and/or otherwise treat the one or more filters 450, 460, 470. Upon using backwash air and/or water 490, backwash waste 491 may be collected from the filters and may exit the system 40.

In order to test the systems and methods of the present invention, wastewater with the characteristics set forth below in Table 1 was used.

TABLE 1
Influent wastewater characteristics

| Parameter | Batch #1 | Batch #2 | Batch #3 |
|---|---|---|---|
| NH₃—N mg/l | <1 | <1 | 1.68 |
| NO₃—N mg/l | 76.5 | 106 | <2 |
| NO₂—N mg/l | <0.02 | <0.02 | 1 |
| pH | 5.89 | 4.7 | 6.5 |
| SO₄ mg/l | 1650 | 1788 | 34 |
| COD total mg/l | 55 | 50 | 120 |
| COD soluble mg/l | 55 | 50 | 90 |
| TSS mg/l | 1.7 | 1.5 | 13.5 |
| Se total mg/l (by ICP) | 1.7 | 2.0 | 0.844 |
| Se soluble mg/l (by ICP) | 1.7 | 1.98 | 0.844 |
| Selenate mg/l (by Hydride) | 1.7 | 2.0 | 0.265 |
| Selenite mg/l (by Hydride) | <0.01 | <0.01 | 0.623 |

Soluble selenium was analyzed using atomic florescence spectroscopy, using an instrument capable of achieving minimum detection limits of 1 ppb.

During experimentation, it was noted that achieving a reducing environment appeared to be a required component in the success of the denitrification and selenium reduction process. Wastewater entering the system was determined to have a positive oxidation-reduction potential in the range of +200 to +300 mV. However, different points in the systems and methods appear to drop the ORP, causing several different reactions to occur within the anoxic and anaerobic reactors. For example, controlling the ORP in the process may be achieved by feeding the reactors with a carbon substrate. As the ORP approaches 0 mV, denitrification occurs as the nitrate is reducted to nitrogen gas. Specifically:

NO₃⁻+organic C→NO₂⁻+organic C→N₂+CO₂+H₂O

As the ORP drops further into the negative range, selenate and/or selenite may then be reduced to an elemental state. Specifically:

SeO₄²⁻+organic C→SeO₃²⁻+organic C→Se⁰+CO₂+H₂O

It was determined that further reduction in the ORP may yield sulfide production, which may precipitate out other trace metals such as zinc, copper, nickel, lead, etc., as metal sulfides.

H₂S+M₂→MS+2H⁺, where M=Metal

When the sulfate is exhausted, further reductions in the ORP may yield methane production and the proliferation of methanogens. Under such methanogenic conditions, metal selenides may be formed.

However, biotic transformations of selenium species are diverse and can be categorized as assimilatory and dissimilatory reduction, alkylation, dealkylation and oxidation. Water soluble selenite and selenate can be reduced to insoluble elemental selenium (Se₀), due to anaerobic microbial selenium respiration, but also mediated by unspecific reductions via sulfate or nitrate reducers. The formation of elemental selenium is desired in selenium treatment systems, as it is considered to be insoluble and thus less bioavailable compared to the oxyanions.

Selenium reduction can be mediated by specific enzymes of selenium-respiring microorganisms that conserve energy for growth from selenium reduction, forming intra- or extracellular elemental selenium nanospheres of ˜150-300 nm diameter loosely attached on the bacterial surfaces. In contrast, unspecific enzymatic selenium reduction by sulfate or nitrate-reducing bacteria can yield not only elemental selenium, but also different side products—e.g. acutely toxic H₂Se. In addition to end-products (i.e. elemental selenium), intermediate products such as selenite and alkylated selenium species coexist within the reactors. Some of the elemental selenium formed particles are not large enough to settle and remain dispersed in the effluent.

Vigorous mixing sloughs these particles off the microbial cell membrane and may even break them into smaller particles. Larger precipitate particle sizes can be formed when precipitates are not sloughed from the microbial cell. The following size fractions of the colloidal dispersion have been observed: 4 to 0.45 μm: up to 52%, 0.45 to 0.2 μm: up to 28%, and particles smaller than 0.2 μm: up to 20%.

Insoluble elemental selenium can be mobilized by microbial re-oxidation to soluble oxyanions (mostly selenite) in oxic conditions, but with a three (3) to four (4) order of magnitude lower rate constant compared to microbial reduction. Solubilization of elemental selenium can proceed alternatively by reduction to dissolved selenide, which readily reacts with metal cations forming strong metal selenide precipitates. Even strong metal selenide complexes are subject to oxidation by microorganisms, as has been demonstrated for the dissolution of copper selenide (CuSe) by Thiobacillus ferrooxidans. The chemical precipitation of dissolved selenide metal cations or coprecipitation of dissolved sulfide with selenite can be classified as biologically induced, in contrast to biologically controlled precipitation of elemental selenium via microbial respiration.

Utilizing systems and methods of the present invention, selenate was substantially completely removed from the liquid phase, but some residual dissolved selenium was observed due to the presence of dissolved selenite, selenocyanate (SeCN), alkylated selenium species (dimethylselenide and dimethyldiselenide) and colloidal selenium particles in the effluent. A mixture of different selenium species can be present in the reactor effluent due to the variety of both abiotic and biotic conversions, posing a major challenge to selenium removal. Soluble selenium in the effluent was found to average 32% of the total while colloidal elemental selenium accounted for 68%.

Active microbial reduction can be accomplished by utilizing a variety of reactor configurations. Among the various designs utilized by the prior are upflow anaerobic sludge blanket, packed fixed film plug flow, and packed upflow reactors. However, such systems typically present results in which the lowest effluent total selenium is approximately 50 ppb and soluble selenium is approximately 25 ppb.

Residual selenium remaining after biological treatment may then be removed in order to reach the new low effluent concentrations required (for example, a desired goal may be approximately 5 ppb). Selenium polishing experiments using adsorbent columns were conducted. Three (3) columns were filled with (i) a ferric oxide media; (ii) an activated alumina media; and (iii) an activated carbon media. Note that selenite, SeCN, alkylated selenium, and nano-sized elemental selenium species are referred to as soluble selenium while total selenium is used to denote the above mentioned soluble selenium species with the addition of non-settlable colloidal elemental selenium with diameter >0.45 μm.

The results of adsorption experiments on the ferric oxide media and activated alumina are presented in Table 2 below. In the case of the ferric oxide media, a retention time of 155 minutes was needed to reduce soluble selenium to 5 ppb. Even after a retention time of 77 minutes, activated alumina was not successful in reducing soluble selenium to 5 ppb. Accordingly, without further modification, these adsorbents do not appear to be ideal candidates for reducing selenium to the 5 ppb level in an efficient and economical manner.

TABLE 2
Adsorption results onto ferric oxide and activated alumina media

| | Ferric Oxide Media | | | | Activated Alumina Media | | | | | |
|---|---|---|---|---|---|---|---|---|---|---|
| Retention | Before | 15 | Before | 155 | Before | 14 | Before | 23 | Before | 77 |
| time | adsorption | min | adsorption | min | adsorption | min | adsorption | min | adsorption | min |
| Soluble | 26 | 22 | 18 | 5 | 25 | 27 | 25 | 21 | 40 | 12 |
| Se (ppb) | | | | | | | | | | |

The results of adsorption experiments onto activated carbon (GAC) are shown in Table 3 below. Results indicate that only 24% of selenite is adsorbed while all or substantially all of SeCN, alkylated Se and a great majority of colloidal selenium are adsorbed and removed onto activated carbon. Soluble selenium may be reduced to less than <2 ppb and total selenium of less than approximately <5 ppb are achieved. After a period of use, the activated carbon appeared to shows signs of exhaustion and adsorption rates are diminished. Upon backflushing the activated carbon the adsorption rates temporarily improved.

TABLE 3
Adsorption results onto granular activated carbon

| | Selenite | | SeCN | | Se other | Se | Soluble Se | | Total Se | Total |
|---|---|---|---|---|---|---|---|---|---|---|
| | Before | Selenite | Before | SeCN | Before | other | Before | Soluble | Before | Se |
| | Adsorption | GAC | Adsorption | GAC | Adsorption | GAC | Adsorption | Se GAC | Adsorption | GAC |
| Date | (ppb) | (ppb) | (ppb) | (ppb) | (ppb) | (ppb) | (ppb) | (ppb) | (ppb) | (ppb) |
| Day 1 | 2.1 | 1.6 | 9 | <0.4 | 10 | <1 | 21 | 1.6 | 67 | 4 |
| Day 2 | | | | | | | 22 | 1 | | |
| Day 3 | | | | | | | 6 | 1 | | |
| Day 4 | | | | | | | 6 | 2 | | |
| Day 5 | | | | | | | 7 | 2 | | 5.4 |
| Day 6 | | | | | | | 5 | 0 | 32 | 5.3 |
| Day 7 | | | | | | | 9 | 5 | | |
| Day 8 | | | | | | | 8 | 11 | | |
| Day 9 | | | | | | | 14 | 4 | | |
| Day | | | | | | | 13 | 3 | | |
| 10 | | | | | | | | | | |
| Day | | | | | | | 11 | 10 | | |
| 11 | | | | | | | | | | |
| Day | | | | | | | 12 | 7 | | 23 |
| 12 | | | | | | | | | | |

Although granulated activated carbon was tested, it is fully contemplated that other materials with sufficient surface area characteristics (for example, sufficient surface area, a proper surface area characteristics—such as a labyrinth) may also adequately trap the nonsoluble elemental selenium. For example, zeolites (a microporous aluminosilicate mineral) or a silica gel may be used. Similarly, an expanded clay material may be used, such as that marketed under BIOLITE™ by the present assignee INFILCO-DEGREMONT.

Although the above methods and systems have been described generally in accordance with the figures, it should be understood that the above descriptions and figures are merely representative, selected examples. Variations and/or substitutions may be made as appropriate by those skilled in the art. For example, although we have shown selected biological reactors in various shapes and configurations and made from selected materials, it should be understood that such shapes, configurations and materials can be changed as appropriate in accordance with the surrounding environment makes practicable. Also, biological reactors may contain support media to provide a means of attached biological growth in addition to the suspended growth fraction. Of course, other components and steps known in the art may be added to meet various conditions at particular sites.

What is claimed is:

1. A method of treating wastewater comprising selenium in the form of water soluble selenates, selenites, and/or selenides, the method comprising:
a chemical/biological treatment process, causing the water soluble selenates, selenites, and/or selenides in the wastewater to be converted into insoluble elemental selenium; and
a physical treatment process, trapping the insoluble elemental selenium in a filtration device.

2. The method of claim 1, wherein the chemical/biological treatment process comprises:
introducing the wastewater into an anaerobic biological reactor, the anaerobic biological reactor substantially reducing the amount of sulfate and/or reducing the heavy metals in the wastewater, the anaerobic biological reactor comprising selenium reducing organisms to reduce selenates, selenites, and/or selenides into insoluble elemental selenium.

3. The method of claim 2, wherein the anaerobic biological reactor reduces at least a portion of the water soluble selenates, selenites, and/or selenides from anaerobic microbial selenium respiration.

4. The method of claim 2, wherein the chemical/biological treatment process further comprises:
prior to introducing the wastewater into the anaerobic biological reactor, introducing the wastewater into an anoxic biological reactor, the anoxic biological reactor substantially denitrifying and/or reducing the heavy metals in the wastewater, and providing the output of the anoxic biological reactor as an input to the anaerobic biological reactor.

5. The method of claim 2, further comprising maintaining the anoxic biological reactor in the range of about −50 to −300 mV.

6. The method of claim 2, further comprising maintaining the anaerobic biological reactor in the range of −200 to −500 mV.

7. The method of claim 1, wherein physical treatment process comprises filtration using one or more filters, screens, or adsorbent materials.

8. The method of claim 7, wherein the physical treatment process comprises using granulated activated carbon to capture the insoluble elemental selenium.

9. The method of claim 7, wherein the physical treatment process comprises the use of multiple filters with different filtration media.

10. The method of claim 9, wherein the multiple filters with different filtration media comprise at least a sand filter and a granulated activated carbon filter.

11. The method of claim 1, wherein the system outputs an effluent and which produces less than about 2 ppb soluble selenium in the effluent.

12. The method of claim 11, wherein soluble selenium comprises selenates, selenites, selenies, SeCN, alkylated selenium, and nano-sized elemental selenium species.

13. The method of claim 1, wherein the method outputs an effluent and which produces less than about 5 ppb total selenium in the effluent.

14. The method of claim 13, wherein total selenium comprises:
soluble selenium, comprising selenates, selenites, selenies, SeCN, alkylated selenium, and nano-sized elemental selenium species; and
non-settlable colloidal elemental selenium with a diameter greater than approximately 0.4 μm.

15. The method of claim 2, further comprising introducing a supplemental carbon source and/or other nutrients into the anaerobic biological reactor.

16. The method of claim 4, further comprising introducing wastewater from the anaerobic biological reactor into a clarifier.

17. The method of claim 16, further comprising recycling at least a portion of wastewater from the clarifier into the anaerobic biological reactor.

18. The method of claim 4, further comprising introducing a sugar into the wastewater upstream of the anaerobic biological reactor.

19. A system for treating wastewater comprising selenium in the form of water soluble selenates, selenites, and/or selenides, the system comprising:
one or more chemical/biological treatment reactors, the one or more chemical/biological treatment reactors configured to cause the water soluble selenates, selenites, and/or selenides in the wastewater to be converted into insoluble elemental selenium; and
one or more physical treatment devices, the one more physical treatment devices configured to trap the insoluble elemental selenium in a filtration device.

20. The system of claim 19, wherein the one or more chemical/biological treatment reactors comprise:
an anaerobic biological reactor configured to substantially reduce the amount of sulfate and/or reduce the heavy metals in the wastewater, the anaerobic biological reactor comprising selenium reducing organisms to reduce selenates, selenites, and/or selenides into insoluble elemental selenium.

21. The system of claim 20, wherein the one or more chemical/biological treatment reactors further comprise:
an anoxic biological reactor configured to substantially denitrify and/or reduce the heavy metals in the wastewater, and provide the output of the anoxic biological reactor as an input to the anaerobic biological reactor.

22. The system of claim 21, further comprising maintaining the anoxic biological reactor in the range of about −50 to −300 mV.

23. The system of claim 20, further comprising maintaining the anaerobic biological reactor in the range of −200 to −500 mV.

24. The system of claim 19, wherein the one or more physical treatment devices comprise one or more filters, screens, or adsorbent materials.

25. The system of claim 24, wherein the one or more physical treatment devices comprise granulated activated carbon to capture the insoluble elemental selenium.

26. The system of claim 24, wherein the one or more physical treatment devices comprise multiple filters with different filtration media.

27. The system of claim 26, wherein the multiple filters with different filtration media comprise at least a sand filter and a granulated activated carbon filter.

28. The system of claim 19, wherein the system outputs an effluent and which produces less than about 2 ppb soluble selenium in the effluent.

29. The system of claim 19, wherein the system outputs an effluent and which produces less than about 5 ppb total selenium in the effluent.

30. The system of claim 20, further comprising introducing a supplemental carbon source and/or other nutrients into the anaerobic biological reactor.

31. The system of claim 20, further comprising a clarifier, the clarifier receiving wastewater from the anaerobic biological reactor.

32. The system of claim 31, further comprising a recycle line to provide at least a portion of wastewater from the clarifier into the anaerobic biological reactor.

33. The system of claim 20, wherein an external carbon source is introduced into the wastewater upstream of the anaerobic biological reactor.

34. The system of claim 20, further comprising inducing a supplemental carbon source into the anaerobic reactor.

35. The system of claim 20, further comprising a pH adjustment module configured to adjust the pH of the wastewater prior to introduction into the anoxic reactor.

36. The system of claim 19, further comprising an input of backwash air and/or water, and wherein the backwash air and/or water is periodically provided to one or more physical treatment devices.
